(19) United States
(12) Patent Application Publication
(10) Pub. No.: US 2017/0270094 A1
(43) Pub. Date: Sep. 21, 2017

(54) DIALOG CORPUS COLLECTING APPARATUS, METHOD AND PROGRAM

(71) Applicant: KABUSHIKI KAISHA TOSHIBA, Tokyo (JP)

(72) Inventor: Yumiko Shimogori, Kawasaki Kanagawa (JP)

(21) Appl. No.: 15/392,830

(22) Filed: Dec. 28, 2016

(30) Foreign Application Priority Data
Mar. 16, 2016 (JP) 2016-052976

(51) Int. Cl. G06F 17/27; G10L 15/24

(52) U.S. Cl. CPC G06F 17/279; G10L 15/24

(57) ABSTRACT

According to one embodiment, a dialog corpus collecting apparatus includes an assigning unit, an extractor, and a controller. The assigning unit assigns a worker to a second role in accordance with the execution state with respect to a task in which a worker is assigned to a first role. The extractor extracts current candidate responses in reply to a choice that the second role made from past candidate responses with respect to a task including an input from the first role. The controller collects the task information, the input from the first role, and the choice that the second role makes from the current candidate responses as a dialog corpus in association with one another.

### CROSS-REFERENCE TO RELATED APPLICATIONS

This application is based upon and claims the benefit of priority from Japanese Patent Application No. 2016-052976, filed Mar. 16, 2016, the entire contents of all of which are incorporated herein by reference.

### FIELD

Embodiments described herein relate generally to a dialog corpus collecting apparatus, method and program.

### BACKGROUND

The Wizard of Oz (WOZ) method has conventionally been known as a technique of collecting a dialog corpus. In the WOZ method, a dialog corpus is collected by having a dialog between a user role and a system role. Since, however, the WOZ method requires workers who actually have a dialog with each other, it has the problems of taking a lot of trouble with recruiting the workers and increasing costs for practicing the method. To resolve the problems, a method for collecting a dialog corpus using crowdsourcing is proposed.

In the proposed method described above, workers are recruited using crowdsourcing and have a chat with each other in pairs as a user role and a system role to perform the same task. In this method, however, it is likely that the workers will make a response beyond the category of service that can be provided by a dialog system, depending on an exchange between the user and system roles, and thus the words spoken by the workers will be wasted for a target dialog system. In addition, since the workers perform a task in pairs, when one worker is slow in inputting, the other worker has to wait, with the result that a dialog corpus cannot be collected with efficiency.

### BRIEF DESCRIPTION OF THE DRAWINGS

FIG. 1 is a block diagram showing an example of the configuration of a system including a dialog corpus collecting apparatus according to an embodiment.

FIG. 2 is a table illustrating a dialog corpus collecting job stored in a job storage shown in FIG. 1.

FIG. 3 is a table illustrating data stored in an active worker storage shown in FIG. 1.

FIG. 4 is a table illustrating data stored in a dialog task execution state storage shown in FIG. 1.

FIG. 5 is a flowchart illustrating an assigning process.

FIG. 6 is a table illustrating data stored in a dialog task storage shown in FIG. 1.

FIG. 7A is a view showing a screen of dialog between a user role and a system role.

FIG. 7B is a view showing a screen of dialog between the user role and the system role.

FIG. 7C is a view showing a screen of dialog between the user role and the system role.

FIG. 8 is a view illustrating a system role job page.

FIG. 9 is a flowchart illustrating an operation to notify a worker.

FIG. 10 is a table illustrating data of a dialog corpus.

FIG. 11 is a flowchart illustrating an operation of the dialog corpus collecting apparatus shown in FIG. 1.

### DETAILED DESCRIPTION

An embodiment will be described below with reference to the drawings. Hereinafter, the elements which are identical or similar to the elements that have been described are denoted by identical or similar reference signs, and overlapping descriptions will be basically omitted.

An object of embodiments is to provide a dialog corpus collecting apparatus, method and program, which allow a dialog corpus to be collected with efficiency.

In general, according to one embodiment, a dialog corpus collecting apparatus includes a first storage, an assigning unit, a second storage, an extractor, and a controller. The first storage stores task information indicative of a task to collect a dialog corpus, an execution state of the task, information of a worker assigned to a first role, and information of one or more workers assigned to a second role in association with one another. The assigning unit assigns a worker to the second role in accordance with the execution state with respect to a task in which a worker is assigned to the first role. The second storage stores current candidate responses from which the second role makes a choice in reply to an input from the first role and a choice from past candidate responses in association with each other for each task. The extractor extracts the current candidate responses in reply to a choice that the second role made from the past candidate responses with respect to a task including an input from the first role. The controller collects the task information, the input from the first role, and the choice that the second role makes from the current candidate responses as a dialog corpus in association with one another.

### Embodiment

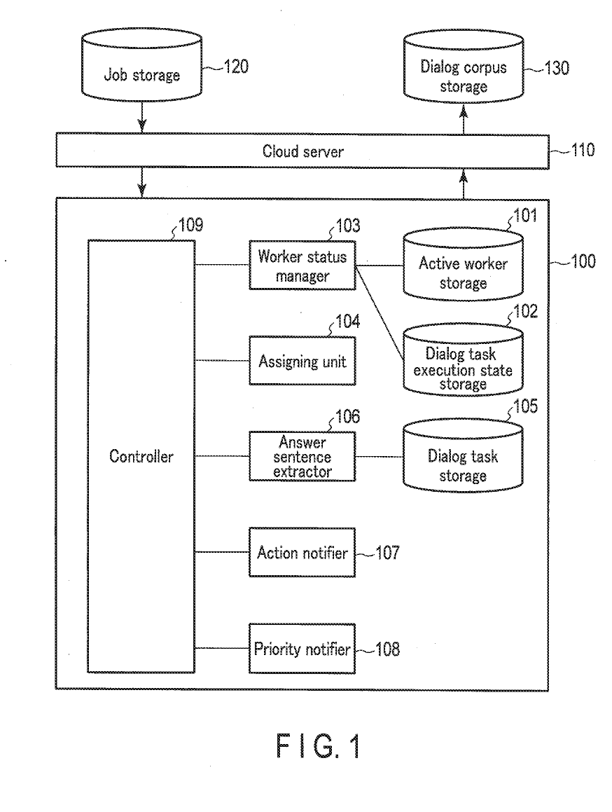

FIG. 1 shows an example of the configuration of a system including a dialog corpus collecting apparatus according to an embodiment. The system includes a dialog corpus collecting apparatus 100, a cloud server 110, a job storage 120 and a dialog corpus storage 130. The dialog corpus collecting apparatus 100 may include at least one of the cloud server 110, job storage 120 and dialog corpus storage 130.

A worker is able to perform various jobs by getting access to the cloud server 110. The jobs are stored in the job storage 120. In response to an instruction of the worker, a job is read out of the job storage 120 and supplied to the cloud server 110. In the embodiment, the worker performs a job for collecting a dialog corpus (a dialog corpus collecting job).

To collect a dialog corpus in the dialog corpus collecting job, workers are divided into a user role (first role) and a system role (second role) to have a dialog between them. The collected dialog corpus can be used in a dialog search system, an automatic guided system, an automatic reservation system, a Q&A system, and the like. In the embodiment, one user role has a dialog with a plurality of system roles in the same task.

Specifically, the dialog corpus collecting job in the embodiment is a job of collecting, as a dialog corpus, a series of dialogs from which a worker of a system role chooses an answer to text input by a worker of a user role. A task sentence presented to the worker of a user role and a task sentence presented to the worker of a system role are different from each other to prevent the workers from looking at their partners' task sentences. The worker of a user role is able to input text using at least one of a free description, a choice from candidate responses and a speech voice. When the worker of a system role makes a choice from candidate responses requiring a free description as an answer, he or she is able to input the free description.

The cloud server 110 provides an application programmable interface (API) for crowdsourcing. In response to an instruction (access) from a worker, the cloud server 110 receives a job from the job storage 120. In the following descriptions, the worker gets access to the dialog corpus collecting job developed on the cloud server 110 to perform a task.

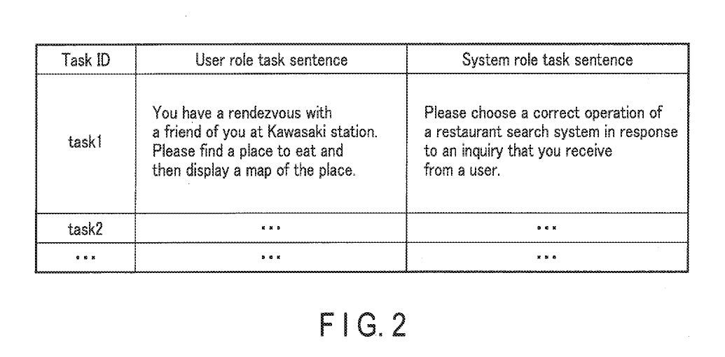

The job storage 120 is used to store various jobs including the dialog corpus collecting job. As illustrated in FIG. 2, the job storage 120 stores a task ID, a user role task sentence and a system role task sentence in association with each other. The task ID represents an ID of each of the tasks that are divided according to a dialog of the situations to be collected. For example, task ID “task1” represents a task to collect an exchange between a user and a system when the user searches for a restaurant using a dialog assistant function.

The dialog corpus storage 130 stores a dialog corpus acquired by performing a dialog corpus collecting job. Here, the dialog corpus storage 130 stores the dialog corpus collected by the dialog corpus collecting apparatus 100.

The dialog corpus collecting apparatus 100 includes an active worker storage 101 (third storage), a dialog task execution state storage 102 (first storage), a worker status manager 103 (manager), an assigning unit 104, a dialog task storage 105 (second storage), an answer sentence extractor 106 (extractor), an action notifier 107 (notifier), a priority notifier 108 and a controller 109. The dialog corpus collecting apparatus 100 manages the status of a worker who is getting access to the cloud server 110 and collects a dialog corpus. Each unit of the dialog corpus collecting apparatus 100 receives and transmits data from and to the cloud server 110 via the controller 109. In the following descriptions, the phrase “via the controller 109” will be omitted.

The active worker storage 101 is used to store data in which worker information indicative of a worker who is getting access to a dialog corpus collecting job, worker information indicative of a worker assigned to a user role, and worker information indicative of one or more workers assigned to a system role are associated with one another.

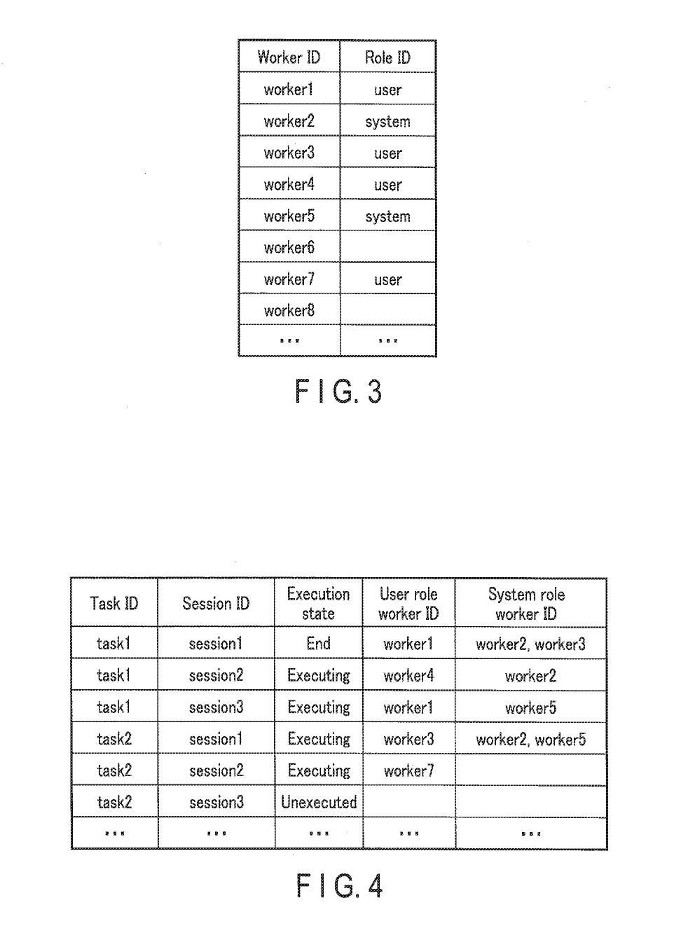

As illustrated in FIG. 3, the active worker storage 101 stores data in which a worker ID and role ID are associated with each other. The worker ID represents an ID to identify a worker who is getting access. The role ID represents a role in the dialog corpus collecting job. For example, role ID “user” represents a user role and role ID “system” represents a system role. The item for role ID to which no role is assigned becomes blank.

The dialog task execution state storage 102 is used to store data in which task information indicative of a task to collect a dialog corpus, an execution state of the task, information of a worker assigned to a user role, and information of one or more workers assigned to a system role are associated with one another. The task may include a session that is a unit to collect a plurality of dialog corpora for a single task. In the dialog corpus collecting apparatus 100, when a session is provided for each task, the execution state of the dialog task execution state storage 102 represents an execution state of the session.

As illustrated in FIG. 4, the dialog task execution state storage 102 stores data in which a task ID, a session ID, an execution state, a worker ID of a user role, and a worker ID of a system role are associated with one another. The session ID represents an ID to identify a plurality of sessions in a single task. The execution state represents an execution state (“end,” “executing,” “unexecuted,” etc.) of a session. The execution state “end” is directed to, for example, a case where a user role had a dialog with two or more system roles in a session. The execution state “executing” is directed to, for example, a case of having a dialog in a session (or waiting for assignment of a system role). The execution state “unexecuted” is directed to a case where no session is started (or no worker is assigned to a user role or a system role). The worker ID of a user role represents a worker ID of a worker assigned to a user role and the worker ID of a system role represents a worker ID of a worker assigned to a system role.

The worker status manager 103 updates data stored in the active worker storage 101 and the dialog task execution state storage 102. For example, the worker status manager 103 updates the data stored in the storages 101 and 102 in response to an instruction from each unit of the dialog corpus collecting apparatus 100 and the cloud server 110. Specifically, when a session in the dialog task execution state storage 102 is closed, the worker status manager 103 updates an execution state corresponding to the session from “executing” to “end.” Instead of each unit of the dialog corpus collecting apparatus 100, the worker status manager 103 may refer to data stored in the dialog task execution state storage 102. The operation of the worker status manager 103 will specifically be described later.

The assigning unit 104 assigns a role to a worker (new worker) who has newly gained access to the dialog corpus collecting job. Specifically, the assigning unit 104 determines whether there is a session that is being executed in the dialog task execution state storage 102. If there is a session that is being executed, the assigning unit 104 assigns a new worker to a system role. If not, it assigns a new worker to a user role. In other words, the assigning unit 104 assigns a worker to a system role with respect to a session (or a task) in which a worker is assigned to a user role in accordance with an execution state of the dialog task execution state storage 102. The new worker also includes a worker to which no role is assigned temporarily because a session that has been so far executed is closed.

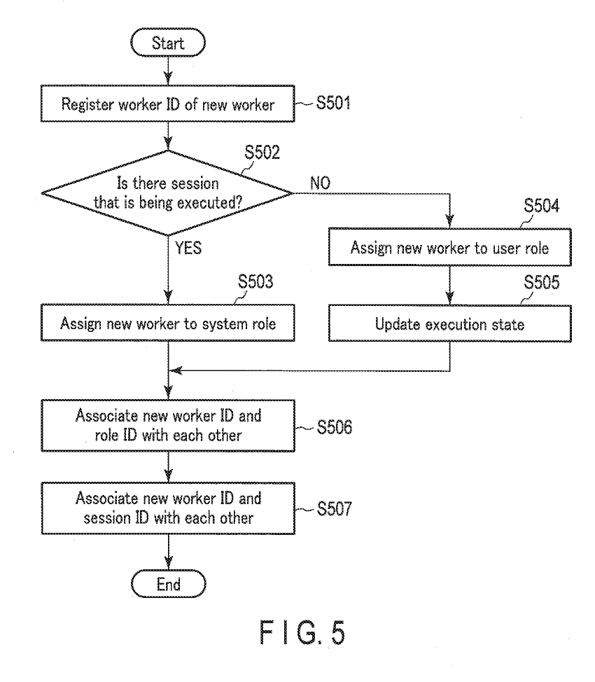

FIG. 5 is a flowchart illustrating a process of assigning a role to a new worker. The process of FIG. 5 starts when the dialog corpus collecting apparatus 100 receives information of a new worker from the cloud server 110.

In step S501, the worker status manager 103 registers a worker ID of a new worker (new worker ID) in the active worker storage 101. If the worker ID has been registered in the active worker storage 101, the process of step S501 is omitted.

In step S502, the assigning unit 104 determines whether there is a session that is being executed in the dialog task execution state storage 102. If there is a session that is being executed, the process moves to step S503. If not, the process moves to step S504.

In step S503, the assigning unit 104 assigns the new worker to a system role for a session whose execution state is “executing” in the dialog task execution state storage 102.

In step S504, the assigning unit 104 assigns the new worker to a user role for a session whose execution state is “unexecuted” in the dialog task execution state storage 102.

In step S505, the worker status manager 103 updates the execution state of the session for which the new worker is assigned to a user role, from “unexecuted” to “executing.”

In step S506, the worker status manager 103 associates the new worker ID and the role ID with each other to update the active worker storage 101. Specifically, the worker status manager 103 adds “system” to an item for role ID when the new worker ID is assigned to a system role and also adds “user” to an item for role ID when the new worker ID is assigned to a user role.

In step S507, the worker status manager 103 associates the new worker ID and the session ID with each other to update the dialog task execution state storage 102. Specifically, the worker status manager 103 adds worker ID to a session to which the new worker is assigned. After step S507, the process ends.

The dialog task storage 105 is used to store data indicating the current candidate responses from which a system role makes a choice in reply to the input from a user role and a choice from the past candidate responses, which are associated with each other. The dialog task storage 105 stores all the combination patterns of the choice and the candidate responses.

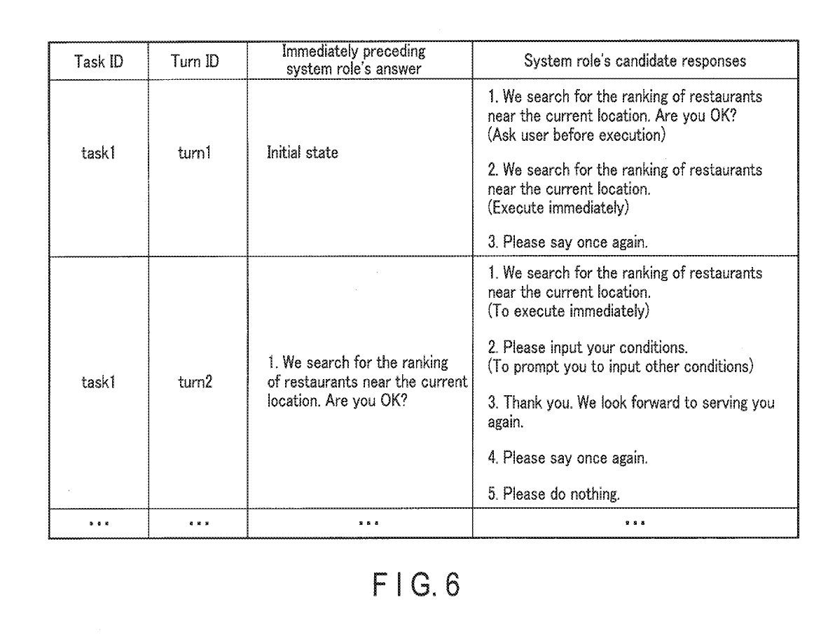

As illustrated in FIG. 6, the dialog task storage 105 stores data indicating a task ID, a turn ID, an immediately preceding system role's answer, and system role's candidate responses, which are associated with one another. The turn ID represents the number of times of exchange in a dialog for the same task. For example, turn ID “turn1” represents a first exchange (turn) and turn ID “turn2” represents a second exchange (turn). The immediately preceding system role's answer represents a system role's answer in a turn (past turn) immediately before a turn during dialog (current turn). The system role's candidate responses represent candidate responses displayed on a Job screen of a worker of a system role, which will be described later.

The answer sentence extractor 106 extracts the current candidate responses in accordance with a system role's choice from the past candidate responses with respect to a task including an input from a user role. Specifically, the answer sentence extractor 106 extracts system role's candidate responses corresponding to the immediately preceding system role's answer from the dialog task storage 105. The answer sentence extractor 106 presents the extracted candidate responses to the system role.

The action notifier 107 notifies a system role of information of a task including a user role's input. The operation of the action notifier 107 will specifically be described later.

When the action notifier 107 notifies a system role of information of a task, if the system role made an answer in the task, the priority notifier 108 notifies the system role of information of the task on a priority basis. The operation of the priority notifier 108 will specifically be described later.

The controller 109 controls each unit of the dialog corpus collecting apparatus 100. The controller 109 receives, for example, input data from a worker who has access to the cloud server 110 and collects it as a dialog corpus. The dialog corpus will specifically be described later.

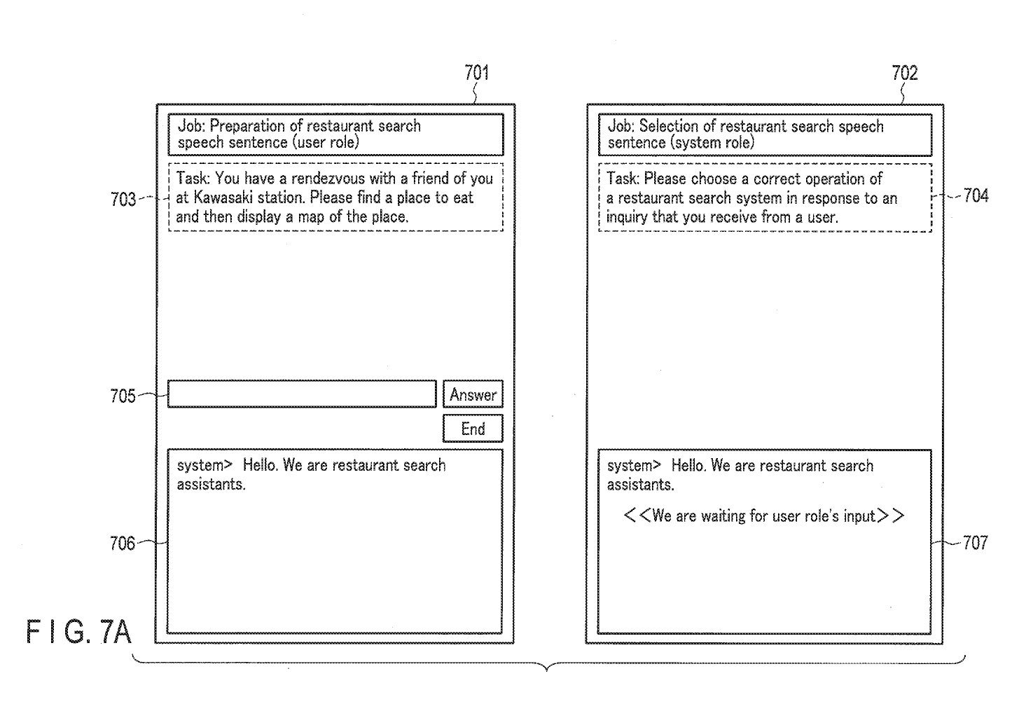

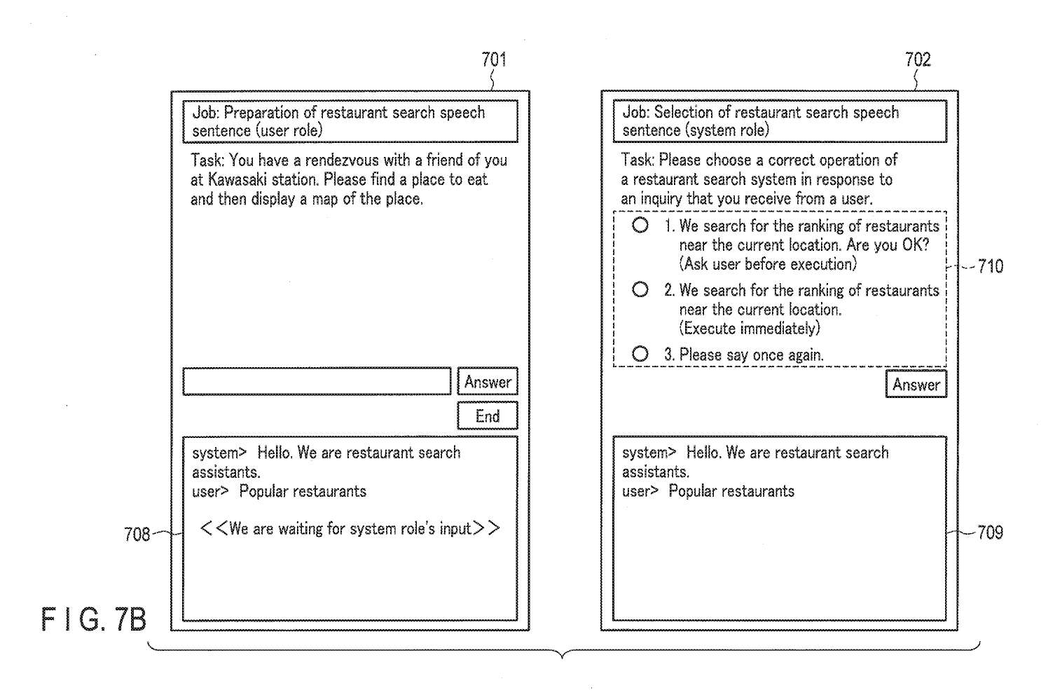

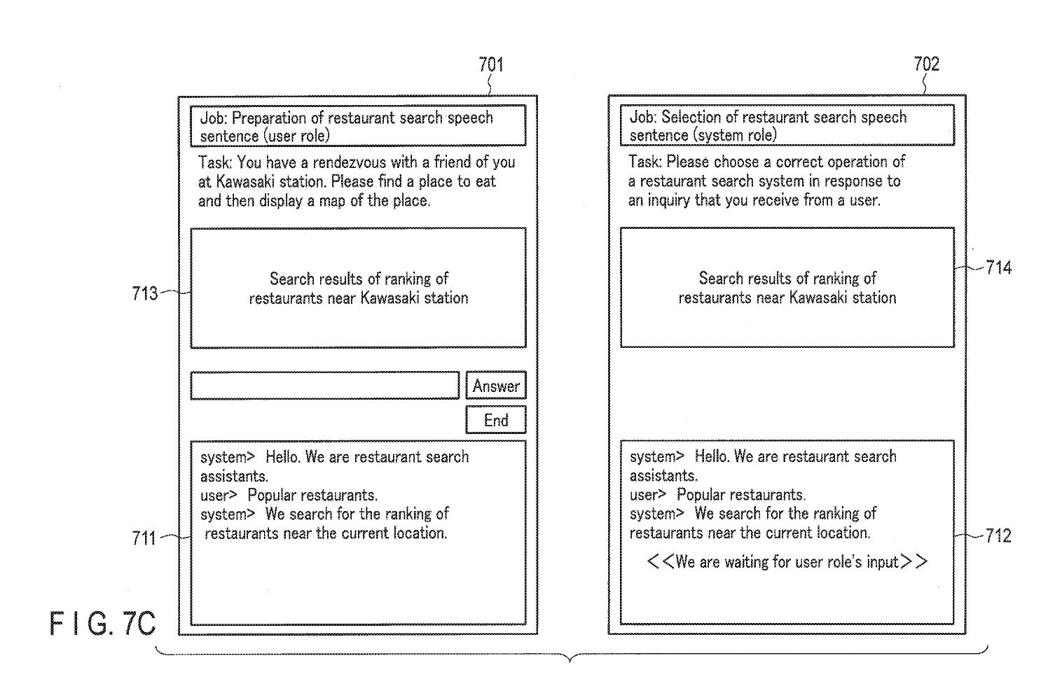

FIGS. 7A-7C illustrate a screen of dialog between a user role and a system role in time sequence. For the user role, a user role display screen 701 is displayed, and for the system role, a system role display screen 702 is displayed. The user and system roles have a dialog with each other using their respective displayed screens. For the sake of brevity, the user role display screen 701 and system role display screen 702 are shown side by side in FIGS. 7A-7C.

FIG. 7A illustrates the initial screen of the dialog. This initial screen is an example of a session in which a worker is assigned to each of the user and system roles for a task, and the system role is waiting for input from the user role.

The user role is presented with a user role task 703 and the system role is presented with a system role task 704. The user role inputs text (speech sentence), which conforms with the user role task 703, to an input blank 705 as an answer. After the user role's answer, the screen shifts to FIG. 7B. In FIG. 7A, a user role history display screen 706 and a system role history display screen 707 each display a dialog history and also may display a status of its dialog partner.

In the screen of FIG. 7B, the user role inputs a speech sentence as an answer and waits for input from the system role. In a user role history display screen 708 and a system role history display screen 709, a speech sentence “popular restaurants” input as an answer by the user role is added and displayed. The system role selects an answer sentence suitable for the behavior of the system from among candidate responses 710 of answer sentences presented in reply to the user role's answer, and inputs it as an answer. After the system role's answer, the screen shifts to FIG. 7C.

In the screen of FIG. 7C, the system role inputs an answer sentence and waits for input from the user role. In a user role history display screen 711 and a system role history display screen 712, an answer sentence “I search for the ranking of restaurants near the current location” input by the system role is added and displayed. On the user role display screen 701 and the system role display screen 702, a search result 713 and a search result 714, which conform with the answer sentence, are displayed. The user role inputs an additional speech sentence when the task is not resolved and chooses “End” when the task has been resolved.

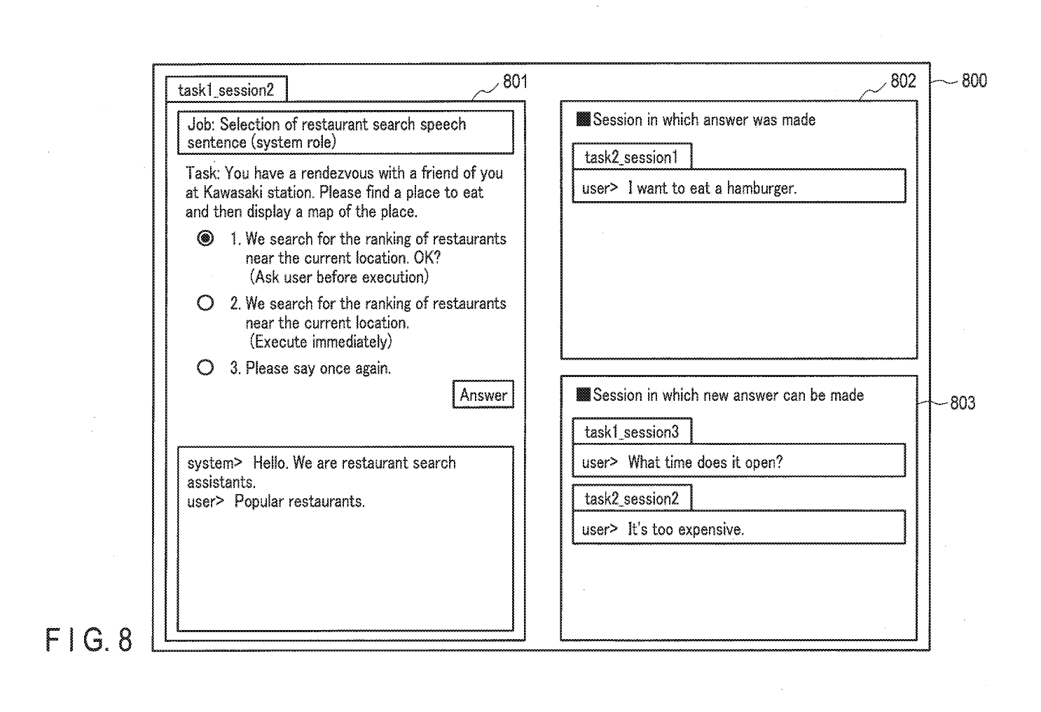

FIG. 8 illustrates a system role job page 800. The system role job page 800 includes a system role display screen 801, a priority selection screen 802 and a regular selection screen 803.

The system role display screen 801 is similar to the system role display screen 702 shown in FIGS. 7A-7C. The system role proceeds with a task in accordance with the display of the system role display screen 801.

On the priority selection screen 802, a list of sessions in which an answer was made is displayed. The system role is able to select, for example, an icon (priority icon) of a session displayed on the priority selection screen 802 to select the session.

On the regular selection screen 803, a list of sessions in which a new answer can be made is displayed. The system role is able to select, for example, an icon (regular icon) of a session displayed on the regular selection screen 803 to execute the session newly. When a worker selects a new session, the worker status manager 103 updates an item of the system role worker ID in the dialog task execution state storage 102, which corresponds to the new session.

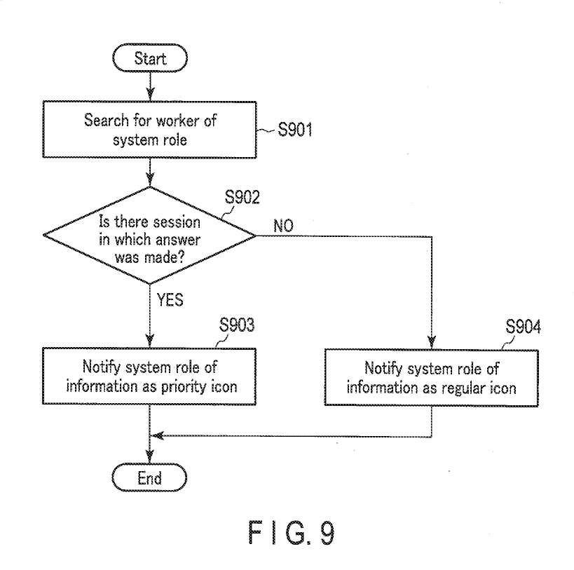

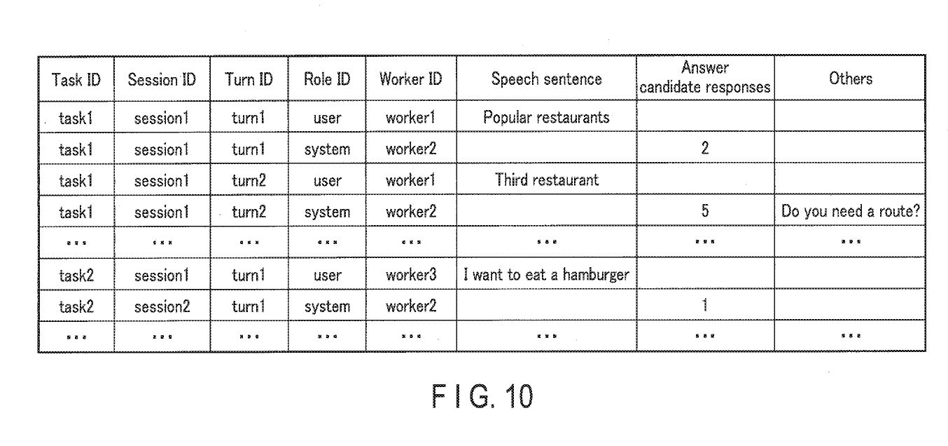

FIG. 9 illustrates a flowchart of an operation to notify a worker. The operation of FIG. 9 starts when a user role inputs a speech sentence regarding a session as an answer.

In step S901, the action notifier 107 searches the active worker storage 101 for a worker assigned to a system role.

In step S902, the priority notifier 108 refers to the dialog task execution state storage 102 to determine whether there is a session in which the user who inputs the speech sentence made an answer. If there is the session, the process moves to step S903. If not, the process moves to step S904.

In step S903, the priority notifier 108 notifies the system role of information of the speech sentence that the user role inputs as an answer regarding a session, as a priority icon. After step S903, the process ends.

In step S904, the action notifier 107 notifies the system role of information of the speech sentence that the user role inputs as an answer regarding a session, as a regular icon. After step S904, the process ends.

When the priority icon and the regular icon are notified to the system role without distinction, the action notifier 107 may notify a worker of the system role of information about the session in step S901 to cause the process to end.

FIG. 10 illustrates data of a dialog corpus. The data of the dialog corpus includes a task ID, a session ID, a turn ID, a role ID, a worker ID, a speech sentence, answer candidate responses, and the others, which are associated with one another. The speech sentence indicates a user role's input. The others indicate, for example, the contents of input of a free description when a system role chooses a candidate response that requires the free description. The dialog corpus collecting apparatus 100 is able to obtain, as a dialog corpus, a set of answer candidate responses of the system role, which correspond to the speech sentence of the user role in a turn in a session, by integrating a task ID, a session ID and a turn ID into the same data.

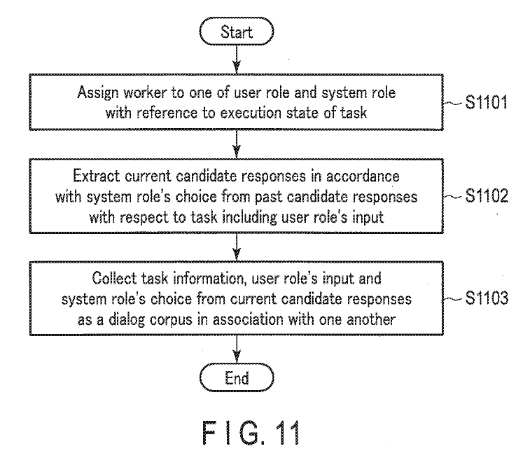

Summarizing the above descriptions, the dialog corpus collecting apparatus 100 according to the embodiment operates as illustrated in FIG. 11.

In step S1101, the assigning unit 104 assigns a worker to one of a user role and a system role in accordance with an execution state of a task. Specifically, when there is no running session, the assigning unit 104 assigns a worker to a user role in a session that has not run in accordance with the dialog task execution state storage 102, and when there is a running session, the assigning unit 104 assigns a worker to a system role of the running session in accordance with the dialog task execution state storage 102.

In step S1102, the answer sentence extractor 106 extracts the current candidate responses in accordance with a system role's choice from the past candidate responses with respect to a task including a user role's input. Specifically, the answer sentence extractor 106 extracts system role's candidate responses corresponding to the immediately preceding system role's answer from the dialog task storage 105.

In step S1103, the controller 109 collects task information, user role's input and system role's choice from the current candidate responses as a dialog corpus in association with one another. After step S1103, the process ends.

As described above, the dialog corpus collecting apparatus according to the embodiment assigns workers who have access to a job to a user role and a system role and extracts the current candidate responses in accordance with a system role's choice from the past candidate responses with respect to a task including a user role's input. Then, the dialog corpus collecting apparatus collects the user role's input and system role's choice from the current candidate responses as a dialog corpus for each task in association with each other.

According to the foregoing configuration, since a system role makes a choice from candidate responses, an irrelevant dialog corpus becomes hard to create. Since, furthermore, a system role makes a choice from candidate responses, the answer time of a system role can be shortened and a large number of dialog corpora can be acquired. Therefore, the dialog corpus collecting apparatus makes it possible to collect a dialog corpus with efficiency.

The instructions in the procedures of the foregoing embodiment can be executed on the basis of programs that are software. If a versatile computer system stores the programs in advance and reads in the programs, the same advantages as those of the dialog corpus collecting apparatus of the foregoing embodiment can be obtained.

The instructions of the foregoing embodiment are recorded on a recording medium, such as a magnetic disk (a flexible disk, a hard disk, etc.), an optical disk (CD-ROM, CD-R, CD-RW, DVD-ROM, DVD±R, DVD±RW, etc.), and a semiconductor memory, as computer-executable programs. If the recording medium is a computer-readable or an embedded system-readable one, it may have any storage format. If the computer reads a program from the storage medium to cause a CPU to execute an instruction described in the program, the same operation as that of the dialog corpus collecting apparatus of the foregoing embodiment can be carried out. When a computer acquires or reads a program, it can do so via a network.

Furthermore, some of the processes to achieve the present embodiment can be performed by, e.g., middleware such as database management software and a network, and an operating system (OS) running on a computer based upon an instruction of a program installed in the computer and embedded system from a recording medium.

The recording medium of the present embodiment is not limited to a medium that is independent of a computer or an embedded system but includes a recording medium that stores or temporarily stores programs which are transmitted via a LAN, the Internet, etc. and then downloaded.

The number of recording mediums is not limited to one. Even if the processes of the present embodiment are carried out by a plurality of mediums, the mediums are included in the recording medium of the present embodiment and may have any configuration.

The computer of the present embodiment is not limited to a personal computer, but includes a processing unit included in an information processing device, a multifunction cellular phone, a microcomputer, etc., and is generally called a device or an apparatus which allows the functions of the present embodiment to be performed by programs.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A dialog corpus collecting apparatus comprising:
a first storage configured to store task information indicative of a task to collect a dialog corpus, an execution state of the task, information of a worker assigned to a first role, and information of one or more workers assigned to a second role in association with one another;
an assigning unit configured to assign a worker to the second role in accordance with the execution state with respect to a task in which a worker is assigned to the first role;
a second storage configured to store current candidate responses from which the second role makes a choice in reply to an input from the first role and a choice from past candidate responses in association with each other for each task;
an extractor configured to extract the current candidate responses in reply to a choice that the second role made from the past candidate responses with respect to a task including an input from the first role; and
a controller configured to collect the task information, the input from the first role, and the choice that the second role makes from the current candidate responses as a dialog corpus in association with one another.

2. The apparatus according to claim 1, further comprising a notifier configured to notify the second role of the task including an input from the first role.

3. The apparatus according to claim 2, further comprising a priority notifier configured to notify the second role of the task if the second role made an answer in the task when the second role is notified of the task.

4. The apparatus according to claim 1, further comprising a third storage configured to store worker information indicative of the worker and one of the first role and the second role in association with each other.

5. The apparatus according to claim 1, further comprising a manager configured to update data stored in the first storage and the second storage.

6. The apparatus according to claim 1, wherein the task includes a session that is a unit to collect a plurality of dialog corpora for a single task.

7. The apparatus according to claim 1, wherein the first role inputs at least one of a free description, a choice from candidate responses, and a speech voice.

8. The apparatus according to claim 1, wherein the second role inputs a free description when the second role chooses a candidate response requiring the free description.

9. A dialog corpus collecting method comprising:
storing task information indicative of a task to collect a dialog corpus, an execution state of the task, information of a worker assigned to a first role, and information of one or more workers assigned to a second role in association with one another;
assigning a worker to the second role in accordance with the execution state with respect to a task in which a worker is assigned to the first role;
storing current candidate responses from which the second role makes a choice in reply to an input from the first role and a choice from past candidate responses in association with each other for each task;
extracting the current candidate responses in reply to a choice that the second role made from the past candidate responses with respect to a task including an input from the first role; and
collecting the task information, the input from the first role, and the choice that the second role makes from the current candidate responses as a dialog corpus in association with one another.

10. A non-transitory computer readable medium storing a computer program which is executed by a computer to provide the steps of:
storing task information indicative of a task to collect a dialog corpus, an execution state of the task, information of a worker assigned to a first role, and information of one or more workers assigned to a second role in association with one another;
assigning a worker to the second role in accordance with the execution state with respect to a task in which a worker is assigned to the first role;
storing current candidate responses from which the second role makes a choice in reply to an input from the first role and a choice from past candidate responses in association with each other for each task;
extracting the current candidate responses in reply to a choice that the second role made from the past candidate responses with respect to a task including an input from the first role; and
collecting the task information, the input from the first role, and the choice that the second role makes from the current candidate responses as a dialog corpus in association with one another.
